(19) United States
(12) Patent Application Publication
(10) Pub. No.: US 2023/0107341 A1
(43) Pub. Date: Apr. 6, 2023

(54) MANAGED BACKDOOR

(71) Applicant: Charles Bowers, Portland, OR (US)

(72) Inventor: Charles Bowers, Portland, OR (US)

(21) Appl. No.: 17/493,412

(22) Filed: Oct. 4, 2021

(51) Int. Cl. G06F 21/31; G06F 21/60; G06F 21/62

(52) U.S. Cl. CPC G06F 21/31; G06F 21/604; G06F 21/6227; G06F 21/6245

(57) ABSTRACT

A method and apparatus for a backdoor managing the secure access and search of confidential information by an entity having a legal authority to search is disclosed.

### TECHNICAL FIELD

The present invention relates to the field of confidential information management system. In particular, embodiments below relate to a managed backdoor for confidential information systems and methods.

### BACKGROUND

Throughout history and across all cultures, societies have engaged in a balancing act between the virtues of a society in which thoughts and information flow freely, and the benefits of privacy and security. The tension between these social objectives is seen in many areas.

In the context of industrial and technological development, societies wish to encourage the creation of new and useful ideas. To do so, society would on one hand give creative citizens the right to own, profit from and protect the confidentiality of their own creative ideas. On the other hand, society would also compel the open disclosure of those creative ideas for the benefit of all. This tension is played out in the creation and enforcement of intellectual property laws.

In the context of business and commerce, society seeks the broad dissemination of market information to reduce the friction and inefficiencies of commercial transactions. On the other hand, society also wishes to protect the privacy of individuals and businesses whose commercial profiles constitute that market information. This tension is played out in the creation and enforcement of privacy laws.

In the broader social context, while all societies have an interest in knowing about and regulating their citizens for the safety of society many societies also choose to protect the freedom and privacy of their citizens from government intrusion. Highly regulated societies in which the government scrutinizes the activities of its own citizens often have very low crime rates and a secure environment, while very open societies that protect privacy and anonymity would often tolerate higher crime rates and a less secure social environment. This tension is played out in the laws regulating criminal investigations and law enforcement.

To date, this balancing act between the preservation of an open society and the protection of privacy has been a “zero sum game.” In the arena of technological and industrial development, when society tightly guards commercial intellectual property, development of new ideas and technology can be impaired. This phenomenon is widely reported and debated with respect to copyright protection on the Internet. Many denizens of the Internet argue that “information must be free” on the Internet to promote the speedy development of new ideas. Yet many others argue that the widespread copying and dissemination of private or proprietary information on the Internet discourages innovation by undermining a creator's right to protect and benefit from his or her creations. The proponents of each side of the argument believe that to the extent one agenda is advanced, the other should be diminished.

In the context of commercial information, commercial interests seek protection of their right to “mine” and aggregate commercial databases through both traditional means and through the new “clickstream” monitoring technologies available on the Internet. On the other hand, citizens seek protection of their privacy against such Big Brother invasiveness. Here too, the proponents on each side of the debate believe that to advance one objective is to diminish the other.

A similar debate with respect to personal or other confidential information has arisen since the unnerving events of September 11th. In the United States, the events of Sep. 11, 2001 have resulted in an intense public discourse over the wisdom of adjusting our own balance from an historically open society affording a great degree of freedom and privacy for citizens, to one that sacrifices a degree of that freedom and privacy for better protection against terrorism. To date, the discourse has continued to treat the issue as a zero-sum game: that is, we should decide how much privacy and anonymity we are willing to exchange for added safety. From diatribes over the U.S. Patriot Act to debates on national ID cards, there is an intense interest in how the balance is adjusted.

In some cases, an entity may have legal authority to examine confidential information, but the confidential information may be protected by encryption, passwords, etc., preventing the entity from examining the confidential information.

### BRIEF DESCRIPTION OF THE DRAWINGS

Embodiments below may be understood by referring to the following description and accompanying drawings. In the drawings:

FIG. 1 is a block diagram illustrating a generalized embodiment of selected components of a confidential information management system in accordance with an embodiment, and the operating environment in which certain aspects of this embodiment may be practiced;

FIG. 2 is a flow diagram illustrating initializing the biometric generator, an aspect of a method to be performed by a confidential information management system in accordance with some embodiments;

FIG. 3 is a flow diagram illustrating bonding a biometric signature to a token, an aspect of a method to be performed by a confidential information management system in accordance with some embodiments;

FIG. 4 is a flow diagram illustrating adding personal data to the token, an aspect of a method to be performed by a confidential information management system in accordance with some embodiments;

FIG. 5 is a flow diagram illustrating methods of ensuring data credibility, an aspect of a method to be performed by a confidential information management system in accordance with some embodiments;

FIG. 6 is a flow diagram illustrating a method of querying data on a token, an aspect of a method to be performed by a confidential information management system in accordance with some embodiments; and

FIG. 7 illustrates one embodiment of a managed backdoor on a device.

FIG. 8 is an example environment illustrating a system with a managed backdoor for confidential information.

FIG. 9 is a flowchart of a process for a managed backdoor to query confidential information.

### DETAILED DESCRIPTION

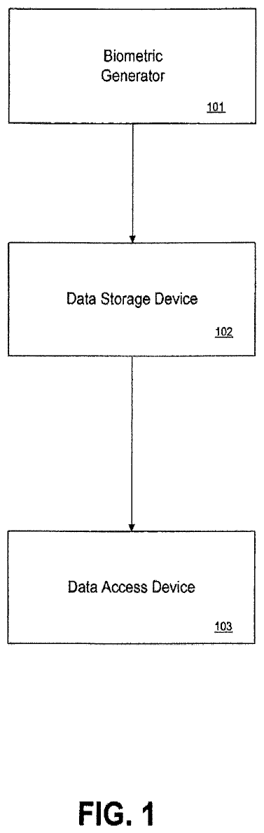

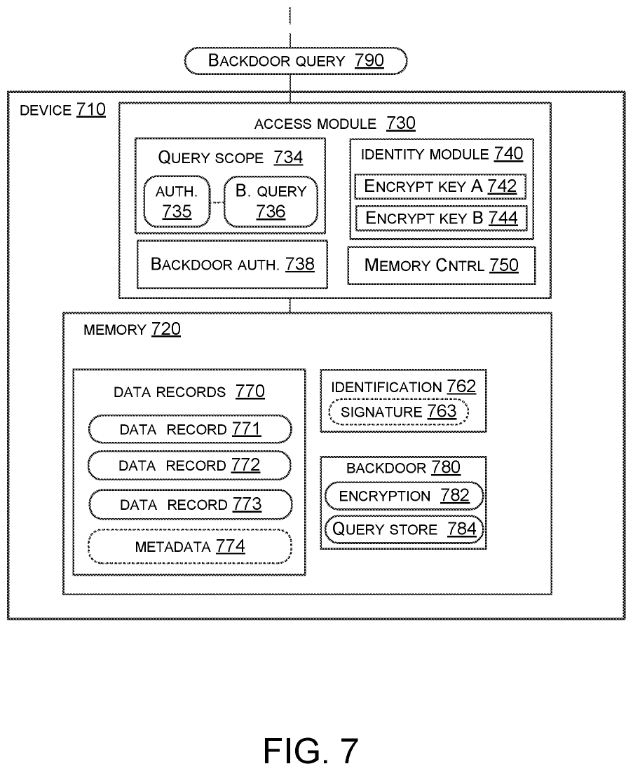

In the following description, various aspects of embodiments of a method and apparatus for confidential information backdoor management are described. Specific details are set forth in order to provide a thorough description. However, it is understood the embodiments herein may be practiced with one, some, or all of these aspects, and with or without some or all of the specific details. FIGS. 1-6 disclose embodiments using a biometric signature, unique identifiers, and/or tokens, and FIG. 7 discloses backdoor managed devices which may or may not utilize the biometric signatures, unique identifiers and/or tokens as disclosed in FIGS. 1-6. Repeated usage of the phrase “in one embodiment” does not necessarily refer to the same embodiment, although it may.

In some instances, well-known techniques of confidential information management have been omitted or simplified in order not to obscure the understanding of this description. For example, specific details are not provided as to certain encryption technology as these techniques are well known by those skilled in the art.

Parts of the description are presented using terminology commonly employed to describe operations performed by a computer system, a biometric generation device or a device having protected or encrypted content. Some of these operations involve storing, transferring, combining and otherwise manipulating signals through electrical, magnetic or optical components of a system. The term “system” may include general purpose as well as special purpose arrangements of these components that are standalone, adjunct or embedded.

Refer now to FIG. 1, which is a block diagram illustrating a generalized embodiment of selected components of a confidential information management system, and the operating environment in which certain aspects of embodiments may be practiced. As shown, the confidential information management system includes a biometric generator (scanner 101), a device used to analyze a highly unique biological characteristic of an individual in a manner that captures that characteristic of the individual in a reliable and replicable way. The captured unique biometric characteristic is referred to as a “biometric signature.” To facilitate the description of embodiments within this disclosure, the term “scanner” is used interchangeably with the term “biometric generator” but this is not meant as a limitation. As is understood by those in the art and contemplated by some embodiments, the biometric generator may include a retinal scanner, a fingerprint scanner, a face recognition system, a voice identification system, a gait analysis device, a DNA analysis system, etc. In one embodiment, the generator analyzes the results of the biological scan, analysis, etc. and converts it to a digital signature which is reliably replicable. However, other embodiments are not limited to using a biometric signature, unique identifier, etc.

Each scanner 101 includes a unique identifier that enables the identification of scanner 101 as the source of the biometric signature. In one embodiment, the unique identifier of scanner 101 may be implemented as an encrypted digital serial number. However, other techniques for implementing the unique identifier may be employed without departing from the scope of this disclosure.

Referring again to the example in FIG. 1, the confidential information management system further includes a data storage device (token 102) to store confidential information about the individual. Because the data storage device is usually, but not necessarily, portable and take the form of a smart card or other similar data storage medium, the term “token” is used interchangeably with the term “data storage device” in embodiments within the scope of this disclosure; however, the methods described herein are applicable to other forms of data storage, such as device 710 in FIG. 7 or other devices within the scope of principles of this disclosure.

With reference to the embodiment in FIG. 1, the biometric signature is bonded to token 102 so that any access to the confidential information stored on token 102 requires reconfirmation of the biometric signature. In some embodiments, bonding the biometric signature to token 102 generates a unique private encryption key used to encrypt the confidential information before storing it on token 102. Nothing on token 102, including the private encryption key, may be accessed unless token 102 is unlocked by the presentment of a biometric signature matching the biometric signature originally bonded to token 102.

Referring yet again to FIG. 1, the confidential information management system further includes a data access device (console 103), which mediates the entry of information onto, and queries against, token 102. Console 103 further facilitates the management, by the individual who is the owner of the confidential information, of the nature and scope of information requested by a querying party as well as the display of information authorized for disclosure to the querying party. In one embodiment, console 103 comprises a data input/output (I/O) mechanism, such as a card reader, a keypad, and a display. Similar to scanner 101, each console 103 includes a unique identifier that enables the identification of the source of the entry of, or access to information on token 102. In one embodiment, the unique identifier of console 103 may be implemented as an encrypted digital serial number; however, other techniques for implementing the unique identifier may be employed without departing from the scope of this disclosure. Alternatively, the biometric generator and the data console may be in a single unit or the matching of the biometric signatures could be done at the biometric generator.

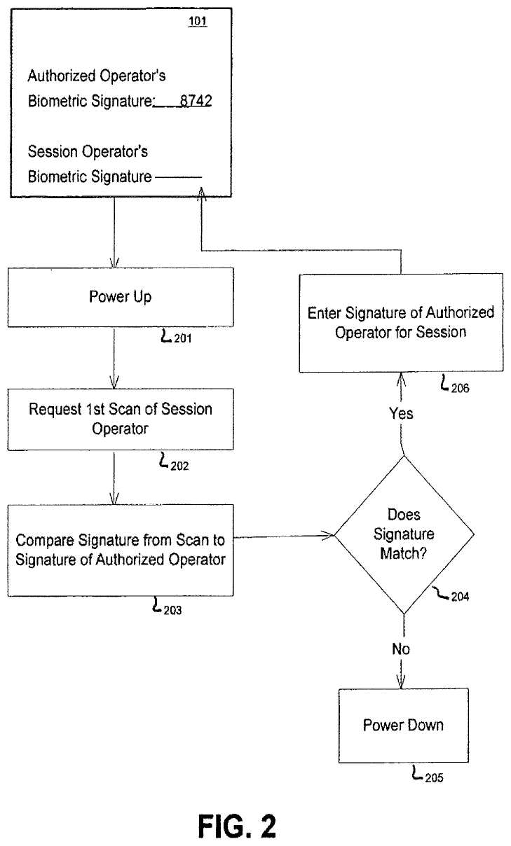

Turning now to FIGS. 2-6, the particular methods of some embodiments are described in terms of software with reference to a series of flowcharts. The methods to be performed by a computer constitute computer programs made up of computer-executable instructions. Describing the methods by reference to a flowchart enables one skilled in the art to develop such programs including such instructions to carry out the methods on suitably configured computers (the processor of the computer executing the instructions from computer-accessible media). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present embodiments are not described with reference to any particular programming language. It will be appreciated that a variety of programming languages may be used to implement the teachings of this disclosure as described herein. Furthermore, it is common in the art to speak of software, in one form or another (e.g., program, procedure, process, application, etc.), as taking an action or causing a result. Such expressions are merely a shorthand way of saying that execution of the software by a computer causes the processor of the computer to perform an action or a produce a result.

FIG. 2 is a flow diagram illustrating initializing the scanner, an aspect of a method to be performed by a confidential information management system in accordance with some embodiments. One of the challenges in a confidential information management system is the ability to safeguard against rogue biometric generator operators. A rogue operator would be someone who does not have the proper authority to use biometric generator 101 or whose use of biometric generator 101 results in biometric signatures that are flawed, substandard, discredited, etc. In the embodiment illustrated in FIG. 2, scanner 101 initializes operation by requiring an operator of scanner 101 to present themselves for analysis and capture of the operator's own biometric characteristic. Scanner 101 records the operator's biometric characteristic in a short-term memory of scanner 101, along with the time and date of the analysis and capture, and further identifies the biometric characteristic as the biometric signature of the current operator. In one embodiment, scanner 101 may be further configured to operate only upon initialization by an individual, or individuals, whose biometric characteristics are included in a set of authorized biometric signatures. Initialization of scanner 101 advantageously enables subsequent data credibility checks described below, including the ability to publish the identities of rogue generator operators, and thereby discount the credibility of data on token 202 recorded by that operator. Initialization of scanner 101 also results in an increase in data credibility by allowing institutions to limit the pool of persons who are authorized to operate scanner 101.

Referring to FIG. 2, in one embodiment, scanner 101 has an authorized operator's biometric signature stored in memory. Upon power up, block 201, the request for the first scan of the session, block 202, is a scan for the current operator's biometric signature. In block 203, the current operator's biometric signature is compared to the stored authorized operator's biometric signature. If the comparison, shown in block 204, is negative, the scanner shuts down, block 205, and does not allow further scans. If the comparison, block 204, is positive, the current operator is the authorized operator and, as shown in block 206, his biometric signature is entered as the session operator of scanner 101.

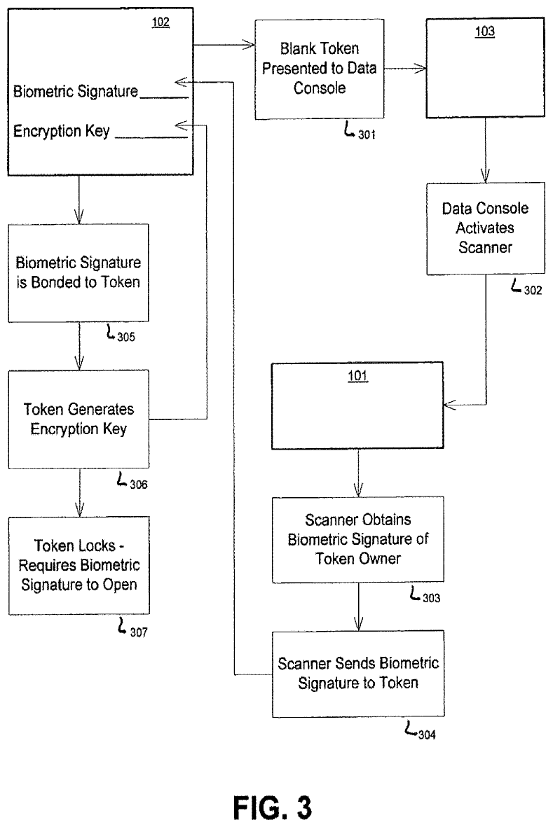

FIG. 3 is a flow diagram illustrating bonding a biometric signature to a token, an aspect of a method to be performed by a confidential information management system in accordance with some embodiments. A blank token 102 is designed to accept, upon first initialization, a digital signature correlating to the results of a captured biometric characteristic of the token owner. Upon the entry of the digital signature, the confidential information management system executes an algorithm that bonds the digital signature from the biometric generator, scanner 101, to token 102, randomly generates a unique digital private key for strong encryption; and sets token 102 to remain locked upon subsequent initializations unless presented with a digital biometric signature having a sufficiently high correlation to the original bonded digital signature such that positive identification is assured.

Referring to FIG. 3, in one embodiment, blank token 102 is presented to data console 103 at block 301. Console 103 activates scanner 101 at block 302. Scanner 101 obtains biometric signature 110 of the token owner at block 303. In block 304, scanner 101 sends biometric signature 110 of the token owner at block 303. In block 304, scanner 101 sends biometric signature 110 to token 102. The biometric signature 110 is bonded to token 102 in block 305 and token 102 generates an encryption key, block 306, which is entered on token 102. At block 307, token 102 locks and requires biometric signature 110 to open.

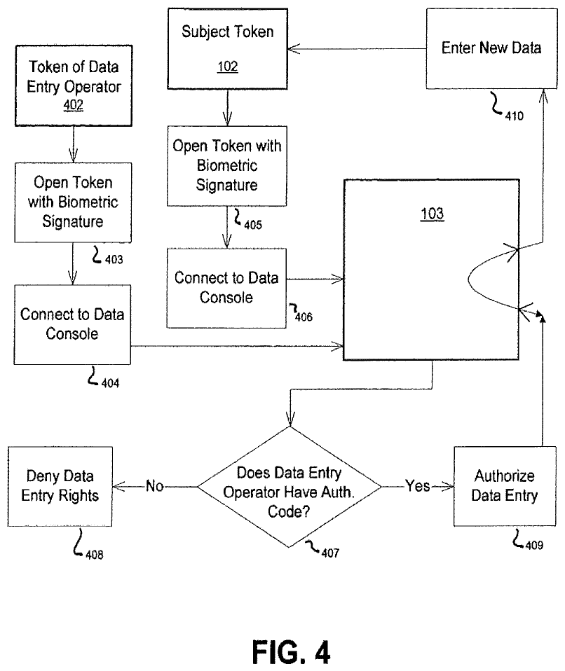

Data credibility can be enhanced by controlling who can enter data and by binding the identity of the data entry operator to each piece of data so entered. Specifically, for a token 102 to be “opened” to enter new data, without using the backdoor it would be presented with the biometric digital signature of the token owner. For a data console 103 to add data to an opened token 102, the console 103 would be presented with the opened token 102 of a data entry person containing a data entry authorization code. In some embodiments, a data authorization code identifies the scope of data for which the data entering person has credibility. For example, a person with a DMV authorization code might be able to enter credit information, but the credibility of that information would be “zero” because the scope of the credible information of the data enterer only embraces the type of information acquired by the DMV. Additionally, if it is learned that a particular data entry person/entity is unreliable, such information can be broadcast so that the credibility coefficient of the data entered by such a person can be reduced. This technique is further described in FIG. 4.

FIG. 4 is a flow diagram illustrating adding personal data to the token, an aspect of a method to be performed by a confidential information management system in accordance with some embodiments. As shown, to enter data onto a token 102 in standard operation, an accessing entity or person would possess a data entry authorization code. However, a backdoor access may use the same authorization code or a different authorization code. The code is issued by a trusted third party, and is bonded to the token of the party so authorized. For a token 102 to have data added to it, the token 102 would be opened using the biometric signature of the token owner, and the data console 103 would be presented with the biometrically opened token of a party possessing a data entry authorization code. The console 103 is used to enter the data, which is then bonded to the token 102 along with the identification of the authorization information of the data entry operator.

Referring to FIG. 4, in one embodiment, an individual presents her token 102 for a transaction which involves adding data to the token, for example, during a transaction where sales history will be stored on the token 102. In block 405, token 102 is opened using the same method shown in FIG. 3. The individual's biometric signature is obtained and compared to the biometric signature stored on token 102 and upon confirmation, the individual is given access to data console 103, as depicted in block 406. The data entry operator's token 402 is opened using the same process, block 403, and the data entry operator is given access, block 404, to data console 103. In addition, an authorization code bonded to the data entry operator's token is tested, block 407. If the authorization code is absent or incorrect, data entry is denied, block 408. However, if a valid data entry authorization code is used then the scope of reliable information associated with that code can be used as part of the calculation of the credibility coefficient. If the authorization code is present and correct, block 407, data entry is authorized, block 409, the data entry operator is allowed access to the data console 103, and new data can be entered, block 410, onto the individual's token 102.

In one embodiment, each piece of personal or other confidential data entered on token 102 can carry a credibility weight based upon the various credibility coefficients attached to it. For example, each piece of confidential information entered onto a token 102 may be linked to: (a) a specific scanner 101; (b) a specific scanner operator; (c) a specific date and time; and (d) a specific data entry authorization code. If the credibility of any of those elements of the data entry process is called into question, the credibility coefficient of the confidential data in that record may be appropriately reduced and broadcast to all data consoles and to all parties authorized to query tokens. The broadcasting of such credibility information could work much like the current system in place for notifying vendors of stolen credit card numbers. An example of a data record and credibility coefficient for an individual for a specific entry date is illustrated in Table 1.

TABLE 1

| Serial No. of scanner | Serial No. of scanner | | | | | |
|---|---|---|---|---|---|---|
| that opened token of | that opened token of | | | Serial No. | Data entry | |
| owner | Data entry operator | Digital sign of | Digital sign of | of data | authorization | credibility |
| (Scanner 1) | (Scanner 2) | Scanner 1's op. | Scanner 2's op. | console | code | coefficient |
| AZ9993420 | BN087923 | 011100011010010001 | 0110100111101010 | AK5950102 | 98720 | 8/10 |

In some cases, a party trusted for purposes of guaranteeing the credibility of certain types of data may not necessarily be reliable with respect to other types of data. Therefore, the relative trustworthiness and security of all entities being granted data entry authorization codes is “baked into” the data entry authorization code, and thus into every piece of data put onto a token 102. Thus, the data entry authorization code has a credibility coefficient limited to certain data types. If data of other types is entered, the credibility coefficient may be zero.

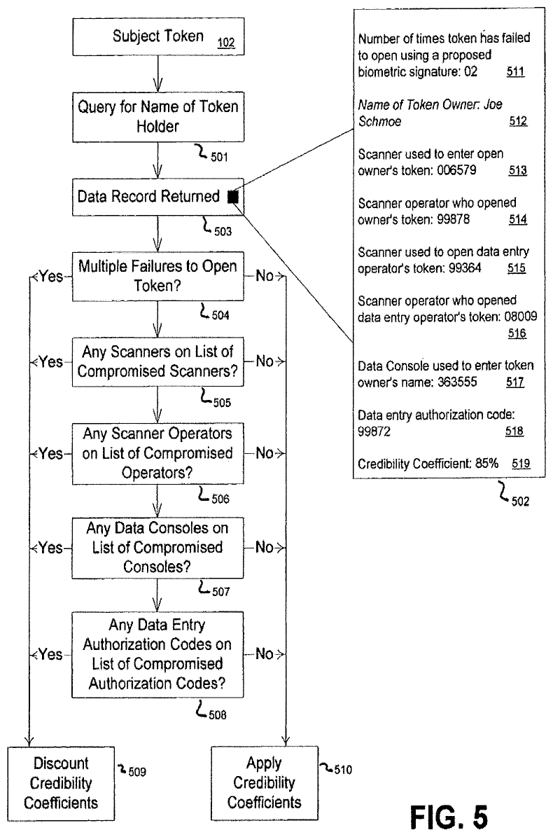

FIG. 5 is a flow diagram illustrating methods of ensuring data credibility, an aspect of a method to be performed by a confidential information management system in accordance with some embodiments. In particular, FIG. 5 illustrates a generalized embodiment of ensuring data credibility in accordance with some embodiments. Each data record entered onto a token 102 may contain, as part of the record, data relating to the entry or acquisition of, and access to, the data record that affects the credibility of the data.

In one embodiment, the digital serial number of the biometric scanner 101 used to acquire the digital signature may be included in the data record. In the event it becomes known that a particular biometric scanner 101 has become compromised, the digital serial number of that scanner 101 can be published, and the credibility coefficient of any data record created with that scanner 101 can be appropriately reduced, potentially to zero. A data record entered onto a token 102 may contain as part of the record, the digital signature of the biometric scanner operator. In the event it becomes known that a particular biometric scanner operator is unreliable, the digital signature of that scanner operator can be published, and the credibility coefficient of any data record created by that scanner operator can be appropriately reduced-potentially to zero. Similarly, in the event that multiple failures to open a token 102 occur, the credibility coefficient of any data record on that token 102 can be appropriately reduced.

Each piece of data entered onto a token will further contain, as part of the data record, a data credibility coefficient indicating the relative trustworthiness of the data. Credibility coefficients may be assigned to specific operators of specific biometric scanners, for example by a trusted private party through the issuance of data entry authorization codes. To enter data onto a token, the token may be opened with the biometric digital signature of the token owner, and the party adding data would activate the data entry function in the console by presenting their own biometrically opened token possessing a data entry authorization code. That code will contain the credibility coefficient of the party entering data, which will be limited to a specifically delimited type of data. For example, a querying party may query about creditworthiness and find a data point entered by a DMV data entry authorization code. The querying party could calculate the credibility of that data point as “zero” because a DMV date entry authorization code does not have credible access to credit information.

For example, authorized trusted workers at a state DMV office may be authorized to enter driver's license information on a token with a high credibility coefficient. Other parties attempting to add such data would have a credibility coefficient of zero, resulting in a negation of reliance on such information. Further, data about, for example, academic records, entered by a DMV official would also receive a low credibility coefficient when calculated by a querying party.

In the embodiment depicted in FIG. 5, token 102 is queried for the name of the token holder in block 501. Data record 502 returned in block 503 includes the number of times token 102 has failed to open using a proposed biometric signature 511, the name of the token owner 512, an identifier of the scanner used to open owner's token 513, an identifier of the scanner operator who opened owner's token 514, an identifier of the scanner used to open data entry operator's token 515, an identifier of the scanner operator who opened data entry operator's token 516, an identifier of the data console used to enter token owner's name 517, a data entry authorization code, a credibility coefficient 519. Data records may include these same fields or different fields depending on the embodiment.

In FIG. 5, myriad items in the data record 502 are used to determine a credibility coefficient. The credibility coefficient is discounted in block 509 or used without change (applied) in block 510 depending on the values of the data items. In block 504, a record of multiple failures to open token 102 results in a discounted credibility coefficient; as does any scanners on the list of compromised scanners, block 505; any scanner operators on the list of compromised operator, block 506; any data consoles on the list of compromised consoles, block 507; and any data entry authorization codes on the list of compromised authorization codes, block 508.

The process of a metadata query allows a token owner to control whether to release specific confidential data to a querying party, or to release the results of a metadata query allowing the querying party to evaluate the answer to a specific question. By protecting the confidentiality of the metadata query contents, token owners are prevented from “gaming the system” by accumulating specific data known to be important for a particular application.

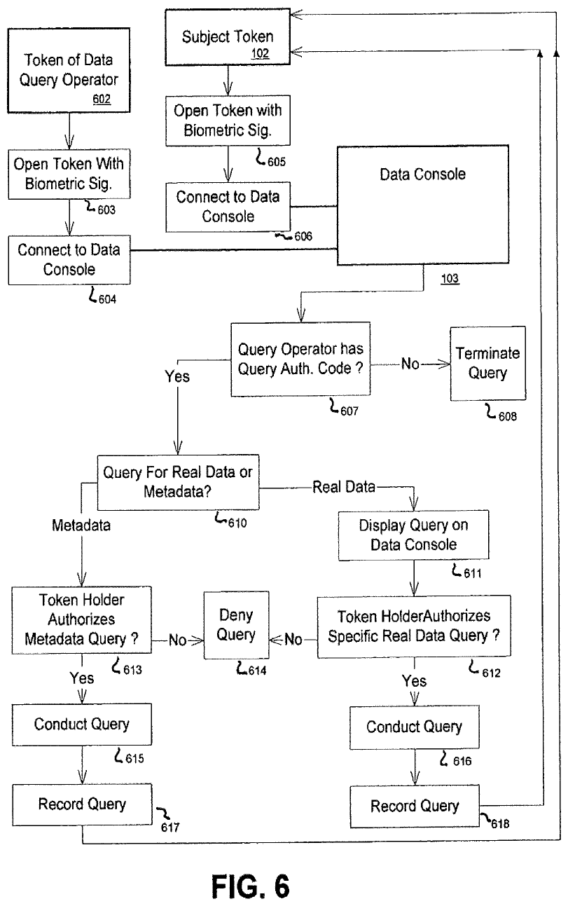

FIG. 6 is a flow diagram illustrating a method of querying data on a token, an aspect of a method to be performed by a confidential information management system in accordance with some embodiments. In particular, FIG. 6 illustrates a generalized embodiment of querying data. For example, one way to query data on a token involves using a data query authorization code. The code is issued by a trusted third party, such as a bank, etc., and is bonded to the token of the party so authorized.

In block 605, the subject token 102 is opened using the biometric signature of the token owner. As discussed above, the biometric characteristic of the subject is scanned and compared to the biometric signature stored on the token 102 and if there is a match, the token is opened allowing a connection to the data console 103 at block 606.

In block 603, the token of the data query operator is opened using the biometric signature of the data query operator by the same technique discussed above and console 103 would be presented with a biometrically opened token which contains a data query authorization code, shown in block 604. At block 607 the data query authorization code is checked. In some embodiments, if the token of the data query operator lacks a credible authorization code, the query is terminated, block 608. In other embodiments, if a data query operator lacks a credible authorization code, a token owner could engage in a preemptive or real time data exchange with the token of the querying party to determine whether the token owner is willing to disclose the requested information.

In block 610, Console 103 is used to enter the data query, and the nature and extent of the query is displayed on the console display for the token owner's review. If disclosure of specific (real) confidential information is asked for, the console displays the query, block 611. The token owner will either authorize or deny release of such information, block 612. The token owner can either deny the query, block 614, or authorize the query, in which case the query is conducted at block 616. If a metadata query is presented, such query is not displayed on the console, but the token owner is requested to authorize release of the metadata, block 613. The token owner can either deny the query, block 614, or authorize the query in which case the query is conducted at block 615.

In one embodiment, for example, the query might ask for release of specific confidential information, such as name and driver's license number, or it might ask for metadata, such as whether the specific data on a token reflects that the token owner is a good risk for a car rental.

An example of metadata query is illustrated in Table 2. The query is for admission onto an Oregon political action campaign mailing list.

TABLE 2

| | “Yes” | “No” | | Credibility | | Total |
|---|---|---|---|---|---|---|
| Query | Value | Value | × | Rating | = | Value |
| Oregon Resident? | 20 | — | × | 3 | = | 60 |
| Over 18 years old? | 10 | — | × | 4 | = | 40 |
| Registered to vote? | — | −7 | × | 6 | = | −42 |
| Democrat? | 15 | — | × | 2 | = | 30 |
| Metadata Query | | | | | | 88 |
| Return Value | | | | | | |

In this example, the issue is whether to offer the token holder admission onto a Democratic Party political action campaign mailing list. The mailing list owner determined that a minimum score of 100 would be required before admission onto the list would be offered. In Table 2, the credibility rating can be a predetermined rating, or can be calculated from the metadata associated with each of the other relevant data points or calculated from the data, etc. The facts that there was highly reliable information that the person was not registered to vote and only weakly reliable information that the person was a Democrat disqualified this person from being admitted. This decision was made without the disclosure of any confidential information. The only thing the querying party received from this process was a score of 88.

To protect the integrity of the system, a process is provided for evaluating if and when data queries are used in an unintended, abusive manner. At block 617 and block 618 a record of the query is stored on token 102. Because each entity querying a token would have a data query authorization code or would present other credible information identifying the querying party as suitable for the query, a record of each query made, including the identity of the querying party, the biometric scanner involved, the date and time of the query, and the nature and extent of each data release can be placed on a token. This information is potentially useful to a token owner in case someone abuses the querying process or the disclosure of confidential data. It is also potentially useful information for law enforcement agencies with appropriate subpoenas. However, as discussed above, this information would generally be locked to all parties to prevent them from “gaming the system.”

FIG. 7 illustrates one embodiment of a managed backdoor device 710. Managed backdoor device 710 includes memory 720 and access module 730. Access module may be firmware, hardware or software, run locally, remotely or in a distributed fashion. For example, for memory drive, access module 730 may be a bus or memory controller, while in a computing device, cell phone, or other device with a processor and memory, access module may be a dedicated controller or processor, a sub-component of a main processor, a sequence of instructions in software or firmware run on the main processor, etc. In some embodiments, device 710 may be a token 102 bonded to a biometric signature as described above with reference to FIGS. 1-6.

Generally, in devices with stored memory, an access module 730 interfaces between the stored memory and an external device, bus, connection, etc. In some embodiments, contents of memory 720 may be encrypted or non-encrypted, locked/firewalled, any combination of write and read enabled, or simply data or metadata stored in memory 720 and accessed through access module 730. In the diagram, access module is shown including a query scope module 734, a backdoor authorization module 738, and identity module 740, and a memory controller 750, however, this is merely one depicted embodiment and various devices 710 will have any of one or a combination of these elements or other control or access elements above or known in the memory storage art.

In the illustrated embodiment, access module 730 includes a query scope module 734, and authorization 735 and backdoor query 736 blocks, modules, etc. Further, identity module includes encryption key A 742, encryption key B 744, and could contain other encryption keys, locks, firewalls, or other access restrictions, etc. for memory 720. By way of example, if data records are stored in memory as encrypted data, one or more encryption keys or decryption keys may be used to store data or decrypt the encrypted data.

In some embodiments, a multi-step process may be utilized to manage a backdoor query 790 discretely. For example, backdoor authorization module 738 may allow establishment of a secure channel to the memory 720 for a first entity by providing a gate key, password, or other access credential, and then operation of the secure channel 792 by a second entity. In this example, a trusted third-party may be the first entity and may be used to check credentials or legal authorization, such as a warrant, of a second entity which may be law enforcement or other entities with legal authority to examine at least some of protected data on a device, token, cell-phone, computer, etc.

Regarding the embodiment shown in FIG. 7, memory 720 is shown containing data records 770, including data record 771, data record 772, and data record 773, as well as metadata 774. Further, memory 720 includes an identification 762 including one or more signatures 763, and backdoor 780 including encryption 782 and query store 784. However, other embodiments may contain merely data, and/or metadata, etc.

In some embodiments, access module 730 provides a managed backdoor to access contents within memory but have the access or aspects of the access recorded in memory or within access module 730 or by access module 730 but on another device or in other memory, etc. For example, a backdoor entity, such as law enforcement, the Federal Bureau of Investigation, CIA, or other intelligence, enforcement or surveillance entities may have backdoor access to contents stored in memory 720, but upon operating the backdoor into memory contents, aspects of the access including the entity identity in identity module 740, the information accessed, the time, the location, the encryption key used in blocks 742 and 744, an authorization, or other identifiers or unique identifiers may be logged. This can benefit backdoor entities by providing access to stored information while also benefiting the device or content owner by making them aware of any accesses to the stored information. Furthermore, by recording the scope of any backdoor access or query to data in memory 720, the device or content owner can determine if the backdoor access exceeded an allowed scope, for example legal scope, of the backdoor accessing entity.

By way of example, data stored in memory 720 may be call logs, texts, pictures, notes, GPS location data, etc. if device 710 is a cellular phone, or may be files, pictures, logs or other data stored in memory 720 if device 710 is a flash memory drive, computer, etc. In some embodiments, the backdoor access may utilize the same encryption key as the owner of device 710, but other embodiments are not restricted in this way. For example, some backdoor accesses may access encrypted data without decrypting it while accessing it, but still record in memory the access or aspects of the accessing party. Additionally, in embodiments where contents of memory 720 are not encrypted but are otherwise locked, firewalled or merely accessible, access module 730 can record aspects of the backdoor access within memory 720, within access module 730, or in other locations on or off device 710, such that the owner or operator of device 710 can see that a backdoor access has happened, what the scope of the access was, etc. In some cases, the identity of the accessing party may be stored, but in other embodiments the identity may be optionally stored or not stored, but still have one or more aspects of the backdoor access stored in memory.

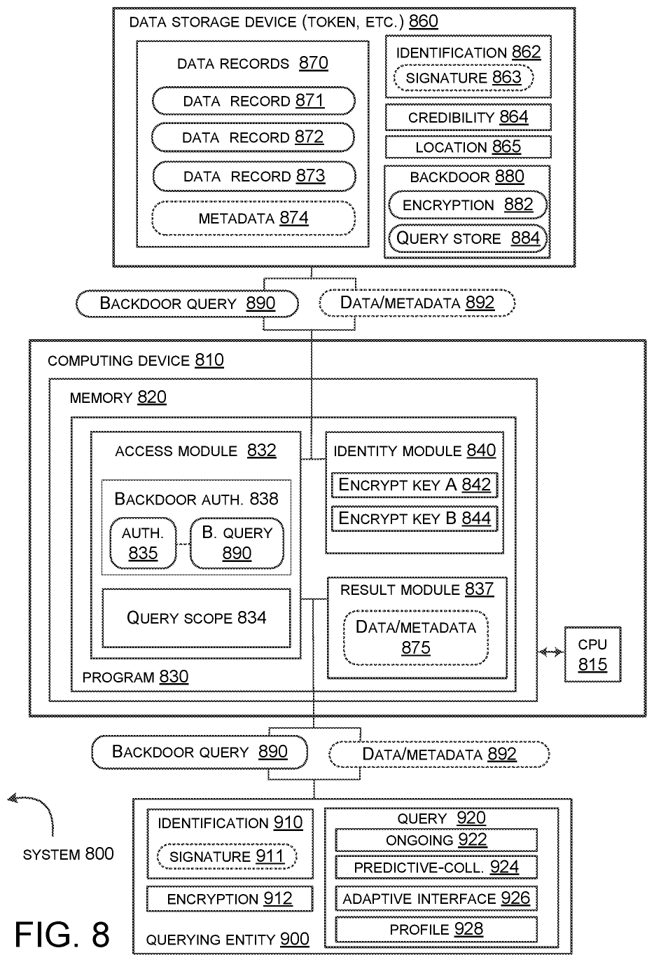

FIG. 8 illustrates an embodiment system 800 for a managed backdoor query of confidential information. Generally, embodiment system 800 manages disclosures of a queried set of information from a confidential information store on a data storage device 860 by utilizing a backdoor authorization and recording aspects of the backdoor query on the data storage device 860 or other managed device or data store. In the present embodiment, system 800 also includes a computing device 810 and a querying entity 900. While system 800 illustrates these as separate devices, they may also share hardware or software with each other. For example, computing device 810 may reside in the same hardware device as data storage device 860 or querying entity 900, or all three may be functional implementations in software or hardware within the same device. For ease of illustration, the current description describes the three elements of system 800 as stand-alone devices.

Data storage device 860 may include one or more data records 870 that contain confidential data and other data. Data storage device 860 may also include an identification block 862 which may include one or more digital signatures 863, a credibility block 864 and location services 865 such as GPS, cellular location services, or other location-based services. Data storage device 860 also includes a backdoor 880, which in the illustrated embodiment also contains and encryption module 882 and a query store 884. Examples of a queried set of information that may be disclosed include data or metadata 892 or a specifically selected subset of data such as one or more individual data records 871-873 out of a confidential information store such as data records 870. Although the storage could reside on a single device, it could also be distributed through multiple devices, including a cloud model storage, a RAID drive, etc., as non-limiting examples.

In embodiment system 800, computing device 810 includes a CPU 815, which may be other forms of processing logic. Device 810 includes memory 820 housing a program 830 within the memory, wherein the program may be implemented in software stored in the memory, in firmware, etc. Program 830 includes an access module 832, having a backdoor authentication 838 having an authorization block 835 and a backdoor query 890, wherein the backdoor query 890 is compared to authorized credentials in authorization 835 and a backdoor authorization 838 is determined. Program 830 further includes a query scope block 834 and an identity module 840, having a first encryption key A 842 and at least one or more additional encryption keys such as encryption key B 844. Program 830 includes a result module 837 to temporarily store confidential information or other data or meta data from data storage device 860 in response to an authorized backdoor query, which may then be sent to querying entity 900.

In the present embodiment system 800, querying entity 900 includes an identification block 910 having a signature 911. Querying entity 900 also includes a query block 920, which includes one or more types of queries, such as ongoing query 922, predictive-collaborative query 924, adaptive interface query 926, and profile query 928, as examples.

In the present embodiment system 800, a querying entity 900, having identification 910, a signature 911, an encryption key or other encrypted content 912, may submit a backdoor query 890 to computing device 810. Upon receiving the backdoor query 890, computing device 810 may then compare the backdoor query 890 with authorized backdoor queries in authorization block 835 to determine if a backdoor authorization 838 is confirmed. If a backdoor authorization 838 is confirmed, then computing device 810 can forward the backdoor query 890 to data storage device 860, whereupon data storage device 860 can generate the data/metadata 892 requested in the query and forward it to computing device 810 and store the backdoor query in query store 884 within backdoor management block 880. If the data/metadata 892 is encrypted, then backdoor management block 880 can decrypt the data using encryption 882 and send decrypted data, or may then send the data in encrypted format if computing device 810 or querying entity 900 have the proper decryption key. In some embodiments, back door 880 may authorize access to one or more data records 870 and provide data/metadata 892 to computing device 810 and/or querying entity 900.

In some embodiments, a managed backdoor system, method or apparatus may also provide a real-time authorization by a token owner of a predetermined subset of information out of a confidential information store in response to a real-time query. The embodiment illustrated in system 800 also provides for automatic disclosure by a token holder of subset of information out of a confidential information store in response to a real-time query. For example, a token owner may pre-authorize the disclosure from a token specific data or metadata responses in connection with specific queries, and/or specific querying parties identified with specific levels of credibility. In this way, a query that matches what has been pre-authorized allows a disclosure of only intended information from a confidential store of information with little or no involvement from the owner of the information. While pre-authorized or real-time authorized queries of data may be managed by an owner of confidential information or other data, this example embodiment may also provide a backdoor access for someone other than the owner of the confidential information or the device, while requiring the backdoor query or aspects of the backdoor query to be recorded for the content owner to manage.

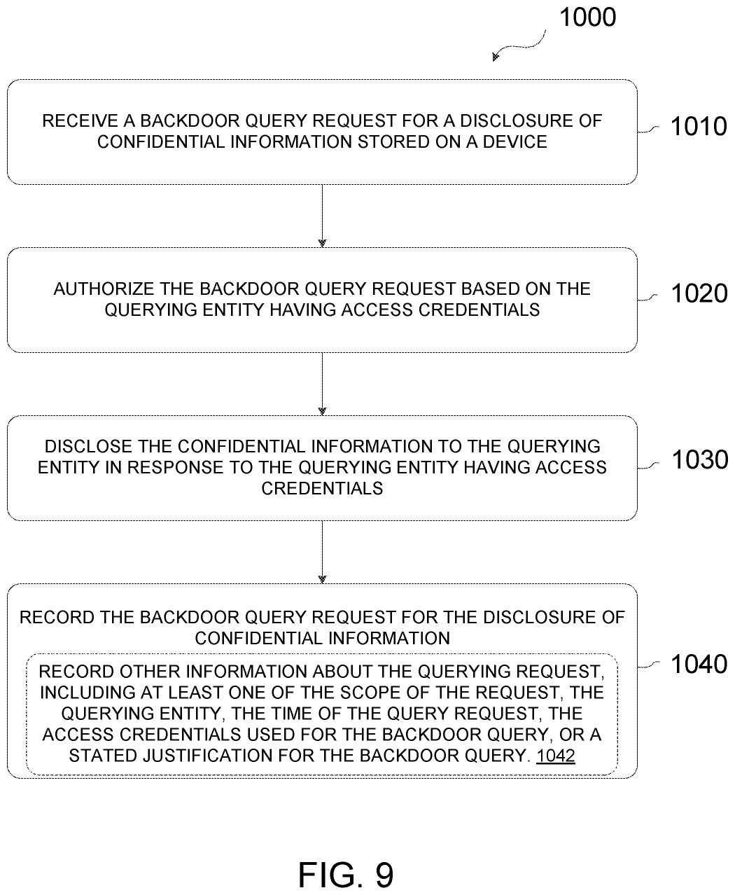

FIG. 9 is a flowchart of an example process 1000 to manage a backdoor query of confidential information. In block 1010, process 1000 receives a backdoor query request for a disclosure of confidential information or other data stored on a device. A backdoor query request in this example is a query by an entity other than the owner of the confidential information or the device that the confidential information is stored on and also without contemporaneous approval to access the confidential information, however, this is an example and other embodiments are not so limited.

In block 1020, the backdoor query request is authorized based on the querying entity having the requisite access credentials. For example, a law enforcement or surveillance entity may have backdoor access credentials in the form of an encryption key, data access credentials, direct memory access through a memory controller, or other form, wherein a request is made to access confidential information or other data on a device or otherwise stored in memory by using the backdoor access credentials. In this way, the query can be controlled by requiring the entity attempting a backdoor query of the confidential information or other data to an entity having a managed set of credentials.

In block 1030, the confidential information is disclosed to the querying entity in response to the querying entity having proper access credentials. Process 1000 then records the backdoor query request for the disclosure of confidential information, so that in exchange for the querying entity having the proper backdoor access credentials and accessing the confidential information or other data, the query request is stored in memory and the owner of confidential information or other data may have a record of the query in block 1040. In block 1042, process 1000 may record other information about the querying request, including at least one of the scope of the request, the querying entity, the time of the query request, the access credentials used for the backdoor query, or a stated justification for the backdoor query.

Accordingly, a novel method and system is described for a method and apparatus for a confidential information management system. From the foregoing description, those skilled in the art will recognize that many other variations within the scope of this disclosure but different than specific embodiments disclosed are possible. Thus, the present disclosure is not limited by the details described. Instead, various embodiments can be practiced with modifications and alterations within the spirit and scope of the appended claims.

1. A method for managing a legally authorized search of confidential information through a dedicated gate on a device, wherein the confidential information is decrypted on the device, the method comprising:
in response to a legally authorized search, a querying entity sending a copy of a warrant and verifying credentials to a trusted third-party;
evaluating sufficiency of the warrant and the verifying credentials of the querying entity, wherein the trusted third-party evaluates the sufficiency of the warrant and the verifying credentials;
the trusted third-party then sending trusted third-party credentials and the verifying credentials of the querying entity to the dedicated gate on the device, if the warrant and verifying credentials of the querying entity are sufficient;
upon successful authorization of the trusted third-party credentials and the verifying credentials of the querying entity, the device sending the trusted third-party a gate key to unlock a secure channel through which the confidential information can be searched by the querying entity; and
the querying entity searching the confidential information on the device through the secure channel.

2. The method of claim 1, further comprising, recording a scope of the legally authorized search and storing the scope of the search on the device.

3. The method of claim 1, further comprising changing the secure channel so the gate key becomes inoperable upon completion of the legally authorized search.

4. The method of claim 1, wherein the scope of the search by the querying entity is limited to the legal authorization of the warrant.

5. A method for managing limited access to stored confidential information, the method comprising:
receiving a limited query request from a querying entity for a disclosure of confidential information stored on a device;
confirming access credentials of the querying entity for the limited query;
generating a limited use gate key for the querying entity using a private key managed by the trusted third party;
generating an authentication key using the third party managed private key and the limited use gate key;
accessing the confidential information using the generated authentication key; and
recording the limited query for the disclosure of confidential information.

6. The method of claim 5, further comprising defining a searchable scope of the confidential information based on a warrant and restricting the limited access of the confidential information to that scope.

7. The method of claim 5, further comprising recording a scope of the limited access and storing the scope of the limited access in memory.

8. A method for managing a backdoor to stored confidential information, the method comprising:
at a trusted third party, receiving a backdoor query request from a querying entity for a disclosure of confidential information stored on a device, wherein the device requires an authentication key to access the confidential information;
confirming access credentials of the querying entity for the backdoor query;
generating a limited use public key for the querying entity using a private key managed by the trusted third party;
generating the authentication key using the third party managed private key and the public key provided to the querying entity;
accessing the confidential information using the generated authentication key; and
recording the backdoor query for the disclosure of confidential information.

9. The method of claim 8, further comprising recording information about the querying request, including at least one of the scope of the request, the identity of the querying entity, the time of the backdoor query request, the access credentials used for the backdoor query, or a stated justification for the backdoor query.

10. The method of claim 8, wherein the authentication key is encrypted, and generating the authentication key involves decrypting the authentication key.
